(19) United States
(12) Patent Application Publication
(10) Pub. No.: US 2011/0142626 A1
(43) Pub. Date: Jun. 16, 2011

(54) SERVICEABLE YAW BRAKE DISC SEGMENTS WITHOUT NACELLE REMOVAL

(76) Inventors: Jesse M. Hanson, Cedar Rapids, IA (US); Ehren W. Van Schmus, Santa Inez, CA (US); Carl G. Wood, Orem, UT (US); Brad D. Banwarth, Hiawatha, IA (US)

(21) Appl. No.: 13/059,566

(22) PCT Filed: Aug. 26, 2009
(86) PCT No.: PCT/IB2009/006642

§ 371 Date: Feb. 17, 2011

Related U.S. Application Data
(60) Provisional application No. 61/211,833, filed on Apr. 2, 2009.

(51) Int. Cl. F03D 7/02; F16D 55/226; F16D 65/12

(52) U.S. Cl. 416/9; 188/71.1

(57) ABSTRACT

A wind turbine yaw brake apparatus includes a circular rotation support base having an inner and an outer cylinder wall. The circular rotation support base is mounted to a top face of a wind turbine tower and a nacelle such that the nacelle can rotate relative to the wind turbine tower. A plurality of brake lining elements are removably mounted to the circular rotation support base. A disc brake unit acts upon the brake aligning elements.

### FIELD OF THE INVENTION

This invention relates to a wind turbine yaw brake apparatus, and more particularly to the serviceability of wear elements thereof.

### BACKGROUND OF THE INVENTION

A wind turbine employs wind turbine electric-power generator units, which utilize the rotation force generated by wind force on a plurality of rotor blades. The blades drive generator units via a rotor shaft and gears. The generator units are controlled by adjusting the pitch angle of the rotor blades to keep generation of power corresponding with the energy of wind and the required generation power at the time of operation.

The generator units are enclosed within a nacelle, along with a transmission mechanism for transmitting the rotation of the main shaft to the generator units, and are supported for rotation in a horizontal plane on a tower.

To ensure that the horizontal-axis wind turbine is producing a maximum amount of electrical energy at all times, a yaw drive is used to keep the rotor blades facing into the wind as the wind direction changes. The wind turbine has a yaw error if the rotor is not aligned with the wind. A yaw error will result in a lower amount of the wind energy impinging upon the rotor area. The yaw angle is the angle between the nacelle's heading and a reference heading into the direction of the wind. In the wind turbine nacelle, a yaw control keeps the blades always toward the direction of wind to allow the wind force to act efficiently on the blades. Rotating the nacelle into the direction of wind does this. The wind turbine yaw control includes a yaw brake. The yaw-brake constrains the nacelle when wind is strong due to extreme wind conditions.

Thorpe U.S. Pat. No. 7,500,546 B2 discloses a steel brake design, which performs the braking function by friction generated between solid steel and sintered metal wear surfaces. The steel surface may be a full annular disc, or may be segmented and connected to form a full annular disc. The sintered metal components are lower in strength, and are segmented and mounted to the annular disc.

The segmented linings contain a number of consumable lining containers or cups, which are fastened to a carrier. The cups are stamped from steel sheet metal and are formed to contain the lining material. Powdered metal is then added to the lining cup through the conventional process of densification and sintering. Brake wear is caused by energy absorbed by the lining surface area when the braking mechanism is engaged.

For wind turbines the prior art has taken a different approach for a yaw brake used with a wind turbine nacelle. An annular brake disc is not suitable because the yaw brake has to be part of the nacelle rotation seat bearing.

An example of the prior art is Shibata U.S. Pat. No. 7,436,083 B2. A rotation seat bearing is located between the top face of a support structure (the tower) and the wind turbine nacelle mounted above the support tower. An integrally formed brake disc is attached between the support structure and the rotation seat bearing. A hydraulically actuated disc brake unit having a hydraulic cylinder and a brake caliper sandwiches the brake disc. Pressing the brake disc from its upper and lower side by the hydraulically actuated disc brake unit causes the nacelle to brake. For servicing, a crane must be employed to remove the nacelle in order to expose the brake disc. The rotation seat bearing together with the brake disc must be removed and lowered by a crane for servicing or replacement.

In wind turbines it is desirable to make the wear items easily serviceable. Currently if a brake disc gets worn or damaged the nacelle must be removed to service the part. Not having to remove the nacelle would significantly reduce downtime and maintenance costs because no external crane would be needed.

It is also desirable to provide a means by which the disc elements can easily be removed and lowered down the tower for repair or replacement.

### BRIEF SUMMARY OF THE INVENTION

Briefly, the invention refers to a wind turbine yaw brake apparatus, which comprises a circular rotation support base having an inner and outer cylinder wall, wherein the circular rotation support base is mounted on the top face of a wind turbine tower, wherein the top face of the wind turbine tower can be integrally formed with the wind turbine tower or can be arranged between the wind turbine tower itself and the rotation support base.

The apparatus further comprises a nacelle mounted to the circular rotation support base. The assembly wind turbine tower top face/rotation support base/nacelle is mounted such that said nacelle can rotate relative to said wind turbine tower, i.e. the rotation support base is either a) affixed to the wind turbine tower top face or b) to the nacelle, wherein in case of a) the nacelle rotates on the rotation support base and in case of b) the rotation support base rotates, together with the nacelle, on the wind turbine top face.

The apparatus further comprises a plurality of brake lining elements, removably mounted to the circular rotation support base, and a disc brake unit acting upon the brake lining elements. Depending on the configuration of the above-mentioned assembly, the disc brake unit is fixed to the nacelle (a) or the wind turbine tower (b).

The apparatus of the present invention is easily serviceable since the wear elements, i.e. the brake lining elements, are removably mounted to the circular rotation support base and can therefore be replaced or repaired without removing the rotation support base and the nacelle from the turbine tower. In case the brake lining elements need to be replaced they are simply disconnected from the rotation support base while the latter remains on the top face of the turbine tower, and the nacelle remains on the rotation support base.

According to the prior art one integrally formed brake disc is arranged between a support structure, i.e. the turbine tower and a rotation support base carrying the nacelle. In accordance with the present invention a plurality of brake lining elements are removably mounted to the circular rotation support base. Once a wind turbine is erected at a given place the wind direction at this place has a preferred direction and therefore the wear of the brake lining elements is not constant. By providing a plurality of brake lining elements it is possible to replace or repair only those elements which are worn out reducing the turbine downtime and maintenance costs significantly.

According to one preferred embodiment of the present invention the brake lining elements are formed as brake disc elements, removably mounted to a cylinder wall of the circular rotation base. The brake disc elements can be removably mounted to the inner, the outer or both cylinder walls of the circular rotation support base providing the turbine nacelle designer with a lot of design flexibility. Depending on the arrangement of the brake disc elements the disc brake unit has to be constructed and arranged accordingly. Providing brake lining elements formed as brake disc elements has the advantage that such elements are very common and therefore the production is very cost efficient.

According to an alternative embodiment of the present invention a protrusion having a flat portion extends from at least one cylinder wall of the rotation support base and brake lining elements are removably mounted on each surface of the flat portion of the protrusion. Again, depending on the arrangement of the brake lining elements the brake disc unit has to be constructed and arranged accordingly. By providing a protrusion on which the brake lining elements are removably mounted it is possible to use much thinner brake lining elements since the protrusion as such provides a certain break strength which must not be provided by the brake lining elements. Furthermore, it is possible to use brake lining elements with different properties on each surface of the flat portion of the protrusion allowing a good adaptability to environmental conditions.

In case brake lining elements should be arranged on both cylinder walls of the rotation support base it is possible to combine both alternatives enhancing the design flexibility of the turbine nacelle designer.

As already mentioned the brake lining elements are removably mounted. It is preferred that the brake lining elements are removably mounted by mechanical fasteners since such fasteners can be released very easily. In accordance with an aspect of the invention, the mechanical fasteners affixing the brake lining elements to the rotation support base are bolts and/or shear pins.

In accordance with a further aspect of the invention, the brake lining elements incorporate lifting holes so the brake lining elements can easily be removed and lowered down the tower. The invention has the advantage that it makes the wear items easily serviceable. Currently if a brake disc gets worn or damaged, due to the location and mounting, the nacelle must be removed to service the part. This invention significantly reduces downtime and maintenance costs because no external crane is needed.

The invention has the advantage that it saves on downtime and inferred crane cost on essential wear items. There is a reduction in cost associated with technical needs as related to repair and rework.

### BRIEF DESCRIPTION OF THE DRAWINGS

FIG. 1 is a partial view in perspective of a first embodiment of the invention employing an external disc design;

FIG. 2 is a cross-sectional view along the view line 2-2 of the disc segment assembly shown in FIG. 1.

FIG. 3 is a top view of an assembled disc of the embodiment shown in FIG. 1;

FIG. 4 is a view in perspective of a second embodiment of the invention employing an internal disc design;

FIG. 5 is a cross-sectional view along the view lines 5-5 of a disc segment assembly shown in FIG. 4;

FIG. 6 is a third embodiment of the invention wherein the disc segments are mounted by pocketed and bonded inserts;

FIGS. 7A-B are a fourth embodiment of the invention wherein the disc segments are mounted by floating pins; and

FIGS. 8A-D are a fifth embodiment of the invention wherein the disc segments are mounted by dove-tailed inserts.

### DESCRIPTION OF THE INVENTION

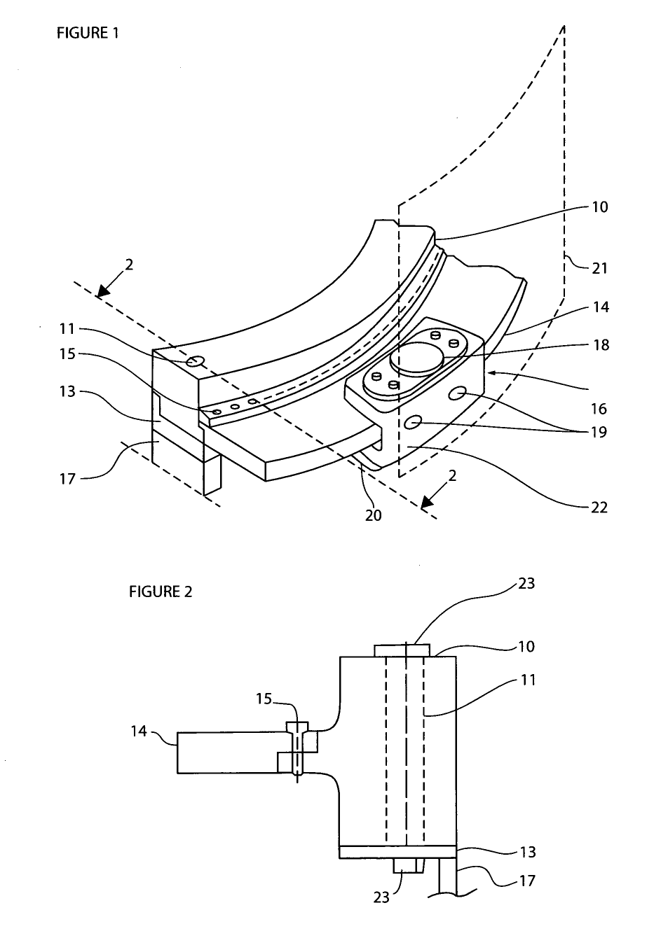

Refer to FIG. 1, which is a partial view in perspective of a first embodiment of the invention employing an external brake disc design, i.e. the brake lining elements 14 are formed as brake disc elements removably mounted to the outer cylinder wall of the circular rotation support base 10. As shown in FIG. 1, an external yaw brake system is shown for locking a wind turbine consisting of blades, a rotor, a rotor shaft, and a nacelle.

A rotation seat bearing support base, or rotation support base 10, is located between the top face 13 of a support tower 17 and the wind turbine nacelle 21 (shown in phantom) mounted above the support tower, i.e. on the rotation support base. A brake disc element 14 is removably attached to the outer cylinder wall of the rotation support base 10.

A hydraulically actuated disc brake unit 16 having a hydraulic cylinder 18, 20 and a brake caliper 22 sandwiches the brake disc element 14 and is mounted to the nacelle 21 (or the tower, see below) in a known manner, e.g. by fasteners 19. By pressing the brake disc on its upper and lower side by the hydraulically actuated cylinders 18, 20, the disc brake unit 16 locks rotation of the wind turbine nacelle 21 relative to the support tower 17.

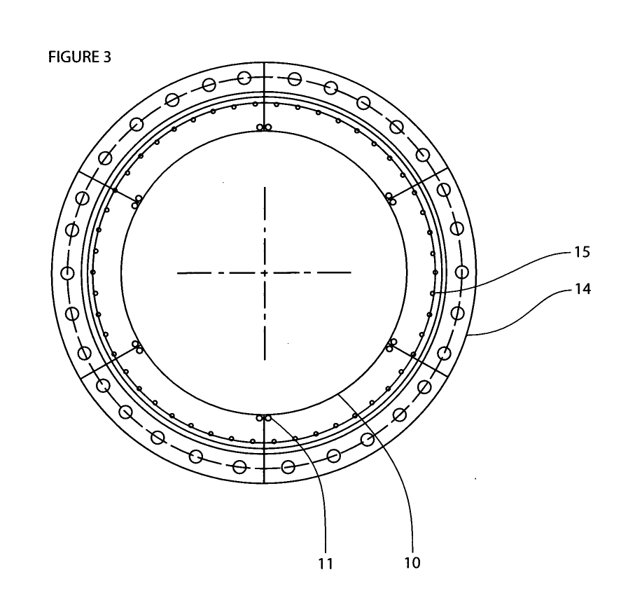

Refer to FIG. 2, which is a cross-sectional view of a brake disc segment rotation support base assembly shown in FIG. 1. As shown in FIG. 2, the brake disc element 14 is attached to the rotation support base 10, by a mechanical fastener 15 which is formed as a bolt or shear pin in this embodiment. In this manner the replaceable wear element, i.e. the brake disc element 14 is attached (bolts 23 connect the rotation support base to the top face 13 of the tower or the nacelle) to the rotation support base. The top face 13 may be a flange 13 of the wind turbine tower 17.

As shown in FIG. 3, for the external disc system, each of six brake disc elements 14 is attached to the rotation support base 10 by mechanical fasteners 15. The rotation support base 10 is, for example, attached to the (not shown) wind turbine tower by bolts through holes 11. In another embodiment the rotation support base may be attached to the nacelle. Furthermore, the rotation support base 10 may be a single piece or may comprise a number of elements, which number may be equal to the number of brake disc elements (six in FIG. 3). In other embodiments a rotation support base with a segment number differing from the number of brake disc elements may be employed.

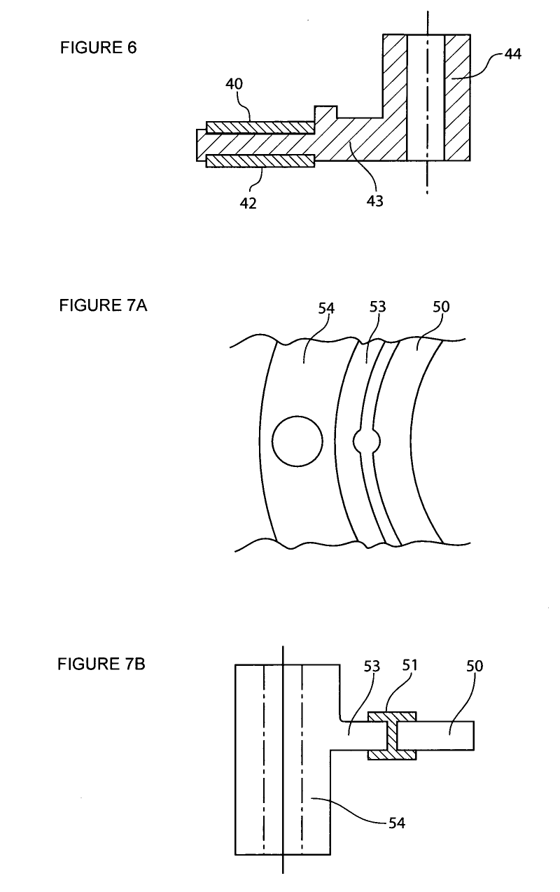

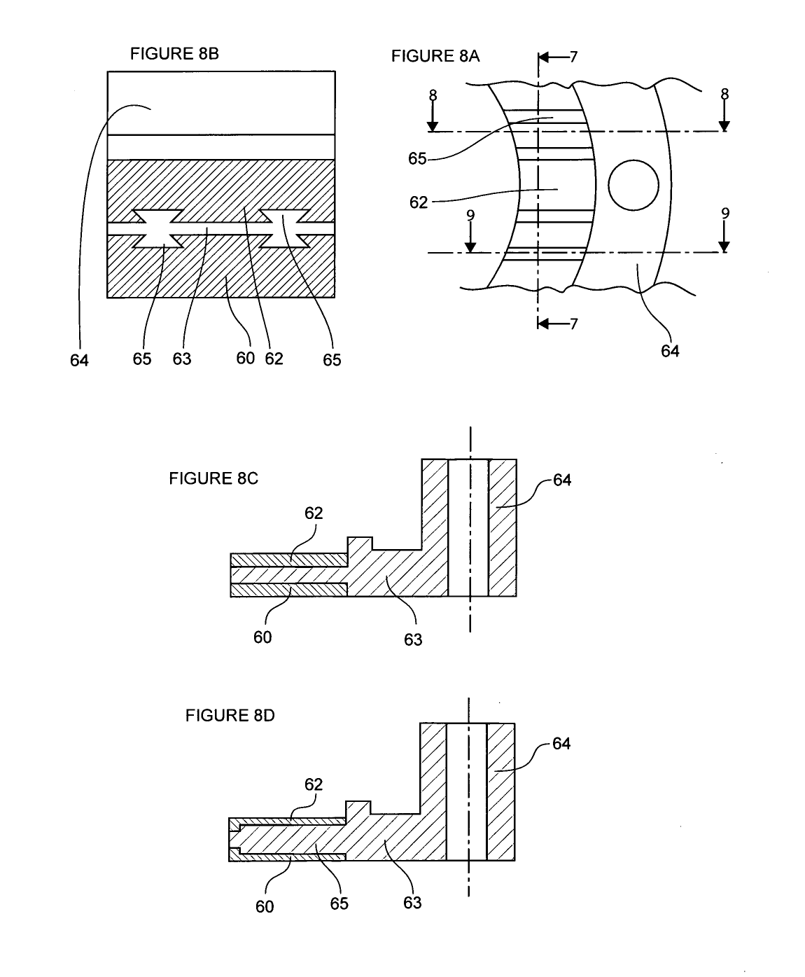

The embodiment shown in FIG. 1 employs only one brake disc mounted to the outer cylinder wall of the rotation support base 10. In another embodiment the yaw brake apparatus may comprise two brake discs mounted to the inner and outer cylinder wall of the rotation support base 10. In such a case the disc brake unit 16 comprises, inter alia, two brake calipers sandwiching the brake discs mounted to the rotation support base and connected to the nacelle. In general, the number of brake calipers, and all corresponding features of the brake unit, depends on the expected forces, i.e. the brake unit can comprise a plurality of brake calipers if the expected forces are high. In FIG. 1 the separate brake disc elements 14 are mounted to the rotation support base 10 by mechanical fasteners. Although this method of fastening the separate brake disc elements is preferred, any other method known to a person skilled in the art may be employed as long as it is assured that the brake disc elements 14 are removably mounted to the rotation support base 10. For example mounted by pocketed and bonded inserts shown in FIG. 6, floating pins shown in FIG. 7, or dove-tailed inserts shown in FIG. 8.

Regarding the material of the brake disc elements no limitations apply as long as the brake disc elements, or the brake disc as such are stable enough for absorbing the forces occurring during a brake application.

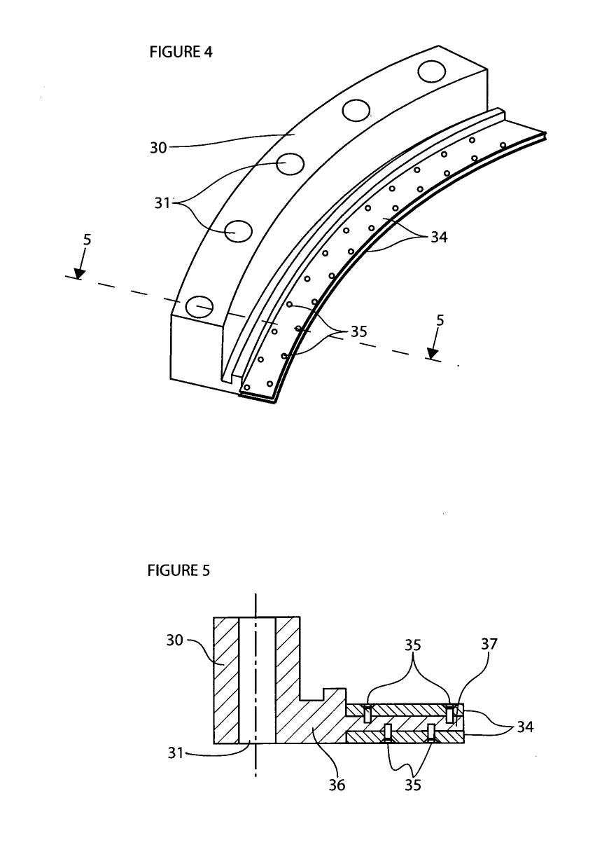

Refer to FIG. 4, which is a view in perspective of a second embodiment of the invention employing an internal disc design. The shown embodiment comprises a segmented rotation support base 30, and only one such element is shown in FIG. 4. A number of such segments complete an entire circular rotation support base 30, similar to that shown in FIG. 3. In FIGS. 4 and 5, an internal yaw brake system is shown for locking a wind turbine (independent from the number of rotation support base segments the term rotation support base is used in this application).

A rotation support base 30 is located between the (not shown) top face of a support tower and the (not shown) wind turbine nacelle. A protrusion 36 having a flat portion 37 extends from the inner cylinder wall of the rotation support base 30. On each surface of the flat portion 37 of the protrusion 36 a brake lining element 34 is removably attached.

The brake lining elements 34 are affixed to the protrusion 36 by mechanical fasteners (bolts) 35. Holes 31 are used to enable bolts to affix the rotation support base 30 to either the (not shown) nacelle (in which case the rotation support base will rotate with the nacelle) or the wind turbine tower top face (in which case the rotation support is fixed to the tower and will not rotate). A hydraulically actuated disc brake unit similar to the one shown in FIG. 1 is used, but is not illustrated in FIG. 4. The brake caliper sandwiches the brake lining elements. By pressing the brake disc on the upper and lower surface of the flat portion of the protrusion by the hydraulically actuated cylinders, the disc brake unit locks rotation of the nacelle relative to the support tower.

As shown in FIG. 4, the brake lining elements 34 are attached to the protrusion extending from the rotation support base 30 by mechanical fasteners 35. In this manner the replaceable wear elements, i.e. the brake lining elements 34, sandwich the protrusion.

Refer to FIG. 5, which is a cross-sectional view of the rotation support base brake lining element assembly shown in FIG. 4. The brake lining elements 34 sandwich the protrusion extending from the rotation support base 30. Holes 31 are used to enable bolts to affix the rotation support base 30 to the (not shown) nacelle or the wind turbine tower top face.

Regarding the material of the brake lining elements no limitations apply as long as the brake lining elements are stable enough for absorbing the forces occurring during a brake application. The brake lining elements on the upper surface and the lower surface may comprise the same or different materials.

The yaw brake apparatus shown in FIGS. 4 and 5 comprises a protrusion on the inner wall of the rotation support base only. In another embodiment a protrusion comprising a flat portion for mounting brake lining elements may extend from both the inner and the outer walls of the rotation support base. Accordingly, such an apparatus comprises a disc brake unit sandwiching the brake lining elements inside and outside of the rotation support base.

The apparatus has been described wherein the support base 10, 30 is divided into segments. However the support base 10, 30 can be constructed as one piece.

In yet another embodiment, the first and the second embodiment may be combined, i.e. a brake disc is mounted to the inner or outer wall of the rotation support base and a protrusion for carrying brake lining elements extends from the other cylinder wall of the rotation support base 10, 30.

The following embodiments pertain to the fastening of brake lining elements, the remaining features of the embodiments are similar to those of the foregoing embodiments. Therefore, the following description pertains only to those details which differ from the above embodiments.

Refer to FIG. 6, which is a third embodiment of the invention wherein the disc segments are provided as pocketed and bonded inserts 40, 42 bonded to a protrusion 43 of a rotation support base 44. This embodiment has the advantage that tapped holes and bolts are eliminated. Refer to FIGS. 7A-B, which are a fourth embodiment of the invention wherein disc segments 50 are mounted by floating pins 51 gripping a protrusion 53 of rotation support base 54.

Refer to FIGS. 8A-D, which are a fifth embodiment of the invention wherein brake lining elements 60, 62 are mounted by dove-tailed protrusions 65 to a protrusion 63 of a rotation support base 64.

FIG. 8A is a top partial view of a rotation support base 64 showing protrusion 63 and protrusions 65 for fastening a (not shown) brake lining element. The dove-tailed shape of the protrusions 65 is shown in FIG. 8B, which is a sectional view along view line 7 of FIG. 8A. The protrusion 63 of the rotation support base 64 is shown with two dove-tailed protrusions 65 on each side of the protrusion 63. The brake lining elements 60, 62 comprise corresponding recesses which can accommodate the dove-tailed protrusions. For fastening the brake lining elements 60, 62 they are simply moved over the dove-tailed protrusions 65 effecting an engagement between the recesses of the brake lining elements and the dove-tailed protrusions.

FIGS. 8C and 8D are cross-sectional views along the view lines 8 and 9 of FIG. 8A showing the different height of the brake lining elements in the area of the protrusions/recesses and between those areas. As can be seen from FIGS. 8C and 8D the height of the protrusions 65 reduced the thickness of the brake lining elements above and therefore protrusions 65 with a minimal height are preferred.

The fifth embodiment shows only one way of fastening the brake lining elements with dove-tailed protrusions. However, this kind of fastening can be employed in other ways, i.e. the brake lining elements can be formed as dove-tailed inserts which are moved in corresponding recesses in the area of the protrusion 63.

While preferred embodiments of the invention have been shown and described, it will be apparent to those skilled in the art that changes can be made in these embodiments without departing from the principles and spirit of the invention, the scope of which is defined in the appended claims.

1-4. (canceled)

5. A wind turbine yaw brake apparatus, comprising:
a circular rotation support base having an inner and outer cylinder wall, the circular rotation support base being mounted to
a top face of a wind turbine tower and
a nacelle
such that said nacelle can rotate relative to said wind turbine tower,
a plurality of brake lining elements, removably mounted to the circular rotation support base, and
a disc brake unit acting upon the brake lining elements.

6. The wind turbine yaw brake apparatus of claim 5, wherein the brake lining elements are formed as brake disc elements, removably mounted to a cylinder wall of the circular rotation support base.

7. The wind turbine yaw brake apparatus of claim 5, wherein a protrusion having a flat portion extends from a cylinder wall of the rotation support base, a brake lining element being removably mounted on each surface of the flat portion of the protrusion.

8. The wind turbine yaw brake apparatus of claim 5, wherein the brake lining elements are removably mounted by one or more of mechanical fasteners, pocketed and bonded inserts, floating pins, and dove-tailed inserts.
